(19) United States
(12) Patent Application Publication
(10) Pub. No.: US 2012/0150752 A1
(43) Pub. Date: Jun. 14, 2012

(54) METHOD AND SYSTEM FOR PROVIDING WORKFLOW CONTROL

(75) Inventor: Gary Karasek, Nova Scotia (CA)

(73) Assignee: VIAPEAK INC., Nova Scotia (CA)

(21) Appl. No.: 13/307,762

(22) Filed: Nov. 30, 2011

(30) Foreign Application Priority Data
Dec. 10, 2010 (CA) 2724913

(51) Int. Cl. G06Q 10/06

(52) U.S. Cl. 705/301

(57) ABSTRACT

A method for generating a workflow control process. A workflow template is provided for each action of a plurality of actions. Each action comprises at least a task to be performed by at least a user. The workflow template for each action is then associated with a respective predetermined control process template. A user is assigned to each of the tasks of the workflow templates. An approving user responsible for approving completion of the action in dependence upon the control process template is assigned to the action. Upon receipt of a request indicative of an action to be performed, a workflow for the action and an associated control process are generated in dependence upon the respective workflow template and the associated control process template. The data indicative of the workflow for the action, the associated control process, the users, and the approving user are stored. Each user is notified of the assigned task in dependence upon the workflow and the approving user is notified of the assigned action.

This application claims priority to Canadian Patent Application Serial No. 2,724,913, filed on Dec. 10, 2010, entitled METHOD AND SYSTEM FOR PROVIDING WORKFLOW CONTROL, the entire contents of which are hereby incorporated by reference.

### FIELD

The present invention relates to the field of workflow management, and more particularly to a method and system for providing workflow control.

### BACKGROUND

Project teams of present day businesses are involved in complex activities comprising numerous actions that are generated during the life time of a project. Typically, each of the actions is important for the integrity—such as, for example, safety, quality, and reliability—of the project and must be diligently managed. In smaller projects comprising a relatively small number of actions management of the actions is typically performed using spreadsheets. However, as projects become more complex, the number of important actions increases substantially, making their management using spreadsheets inefficient, prone to error, difficult to track, and difficult to close out. Typically, a large project generates 2000 or more actions that require diligent management during the life time of the project.

Generally, actions comprise a plurality of tasks which have to be performed according to a predetermined workflow. Especially large projects comprise a plurality of actions that require similar tasks and follow a similar workflow allowing programming of predetermined workflow templates which are then assigned to respective actions.

State of the art workflow management programs typically allow a user to upload a list of actions and enable the user to manually create a corresponding workflow for each of the uploaded actions or to manually assign a corresponding predetermined workflow based on provided workflow templates. Once the workflow for each of the uploaded actions is created, the workflow management program then operates as a workflow tool with reporting and tracking functionality.

However, the manual creation or assignment of the corresponding workflow to an action by the user creates a high risk of the user incorrectly assigning actions, incorrectly defining workflows, incorrectly applying due dates or other logic errors. Furthermore, the state of the art workflow management programs lack the ability of providing a workflow control process for ensuring the diligent management of the actions.

It is desirable to provide a method and system for automatically assigning a corresponding workflow to an action.

It is also desirable to provide a method and system for automatically assigning a corresponding workflow control process to an action.

It is also desirable to provide a method and system that allows upload of a plurality of actions using a spreadsheet document.

### SUMMARY

Accordingly, one object of the present invention is to provide a method and system for automatically assigning a corresponding workflow to an action.

Another object of the present invention is to provide a method and system for automatically assigning a corresponding workflow control process to an action.

Another object of the present invention is to provide a method and system that allows upload of a plurality of actions using a spreadsheet document.

According to one aspect of the present invention, there is provided a method for generating a workflow control process. A workflow template is provided for each action of a plurality of actions. Each action comprises at least a task to be performed by at least a user. The workflow template for each action is then associated with a respective predetermined control process template. A user is assigned to each of the tasks of the workflow templates. An approving user responsible for approving completion of the action in dependence upon the control process template is assigned to the action. Upon receipt of a request indicative of an action to be performed, a workflow for the action and an associated control process are generated in dependence upon the respective workflow template and the associated control process template. The data indicative of the workflow for the action, the associated control process, the users, and the approving user are stored. Each user is notified of the assigned task in dependence upon the workflow and the approving user is notified of the assigned action.

According to another aspect of the present invention, there is further provided a storage medium having stored therein executable commands for execution on a processor. The processor when executing the commands generates a workflow control process. A workflow template is provided for each action of a plurality of actions. Each action comprises at least a task to be performed by at least a user. The workflow template for each action is then associated with a respective predetermined control process template. A user is assigned to each of the tasks of the workflow templates. An approving user responsible for approving completion of the action in dependence upon the control process template is assigned to the action. Upon receipt of a request indicative of an action to be performed, a workflow for the action and an associated control process are generated in dependence upon the respective workflow template and the associated control process template. The data indicative of the workflow for the action, the associated control process, the users, and the approving user are stored. Each user is notified of the assigned task in dependence upon the workflow and the approving user is notified of the assigned action.

An advantage of the present invention is that it provides a method and system for automatically assigning a corresponding workflow to an action.

A further advantage of the present invention is that it provides a method and system for automatically assigning a corresponding workflow control process to an action.

A further advantage of the present invention is that it provides a method and system that allows upload of a plurality of actions using a spreadsheet document.

### BRIEF DESCRIPTION OF THE DRAWINGS

One embodiment of the present invention is described below with reference to the accompanying drawings, in which:

FIG. 1 is a simplified block diagram illustrating a computer system for implementing a method for providing workflow control according to one embodiment of the invention;

FIGS. 2a to 2c are a simplified flow diagrams illustrating a method for providing workflow control according to one embodiment of the invention; and,

FIGS. 3a to 3c are is a simplified block diagram illustrating templates for use in the method for providing workflow control illustrated in FIG. 2a.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

Typically, a large project comprises a plurality of activities such as, for example, whitepapers with each activity comprising a plurality of actions such as, for example, creation of a whitepaper and each action comprising a plurality of tasks such as, for example, searching material for the whitepaper. The various actions are usually performed by a large number of different user groups such as, for example, departments of a corporation, outside vendors, and contractors. While embodiments of the invention will be described for workflow control related to actions associated with a single activity and the tasks performed by a single user group for the sake of simplicity, it will become evident to those skilled in the art that the embodiments of the invention are not limited thereto, but are also applicable for use in projects comprising a plurality of activities and tasks to be performed by a plurality of user groups in numerous types of industry and business.

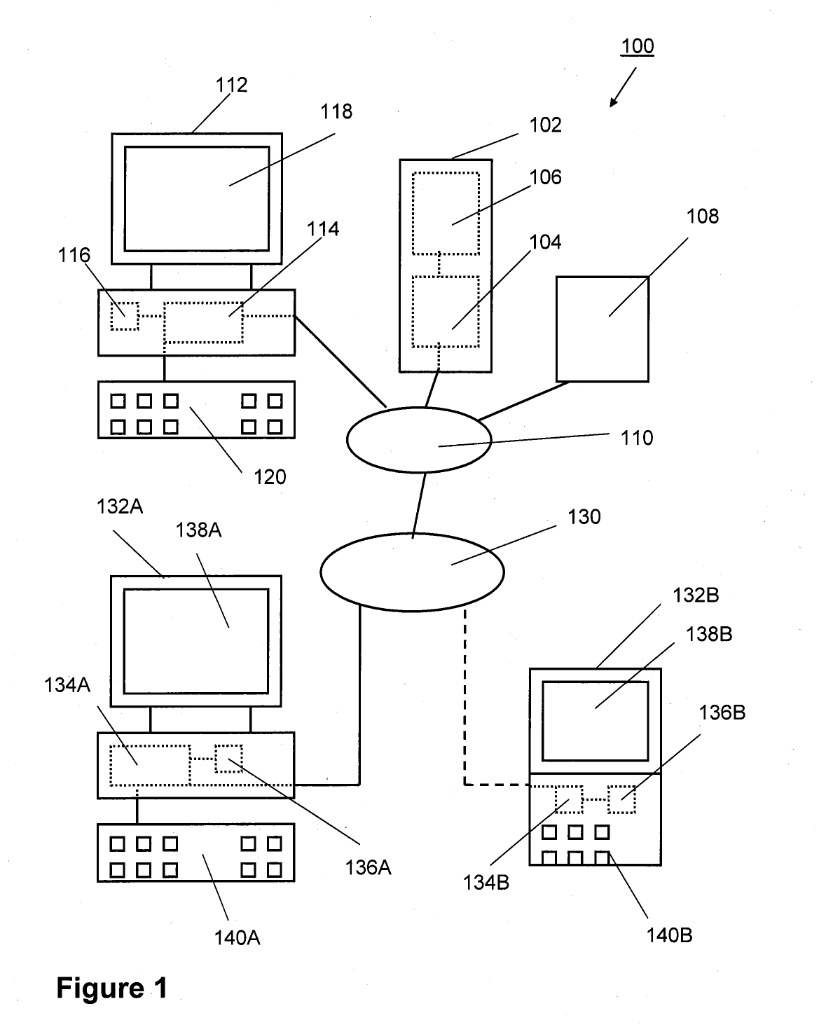

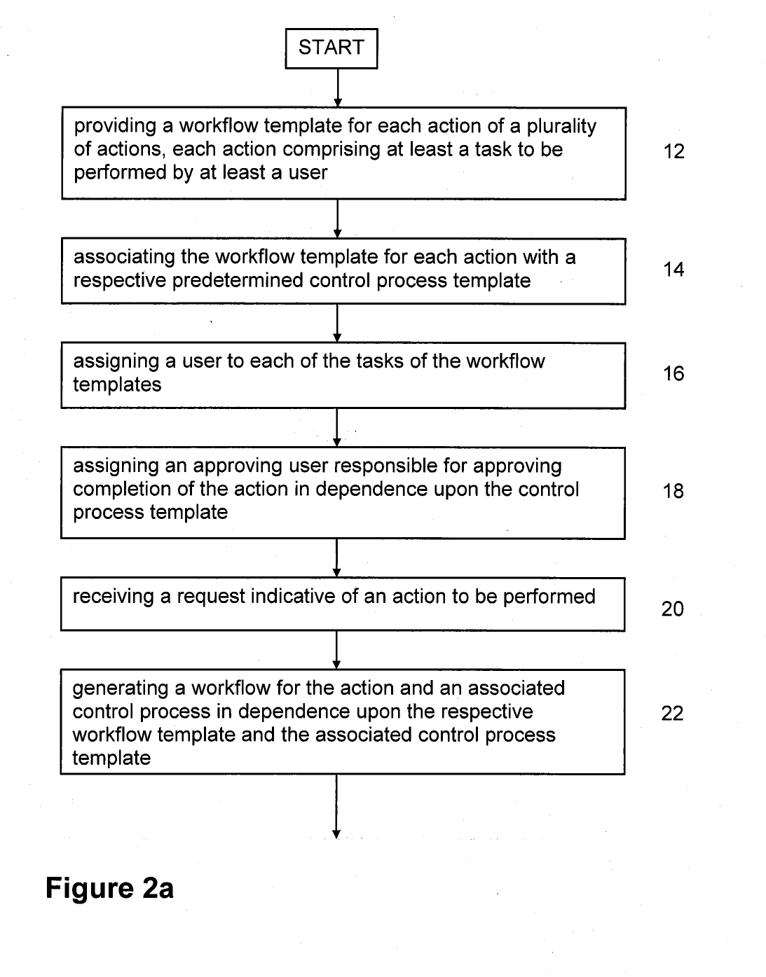

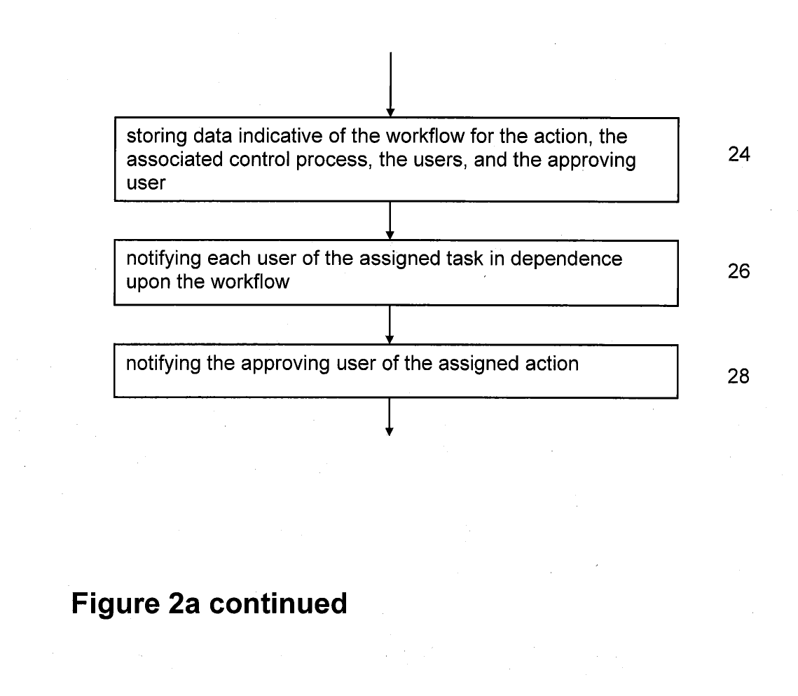

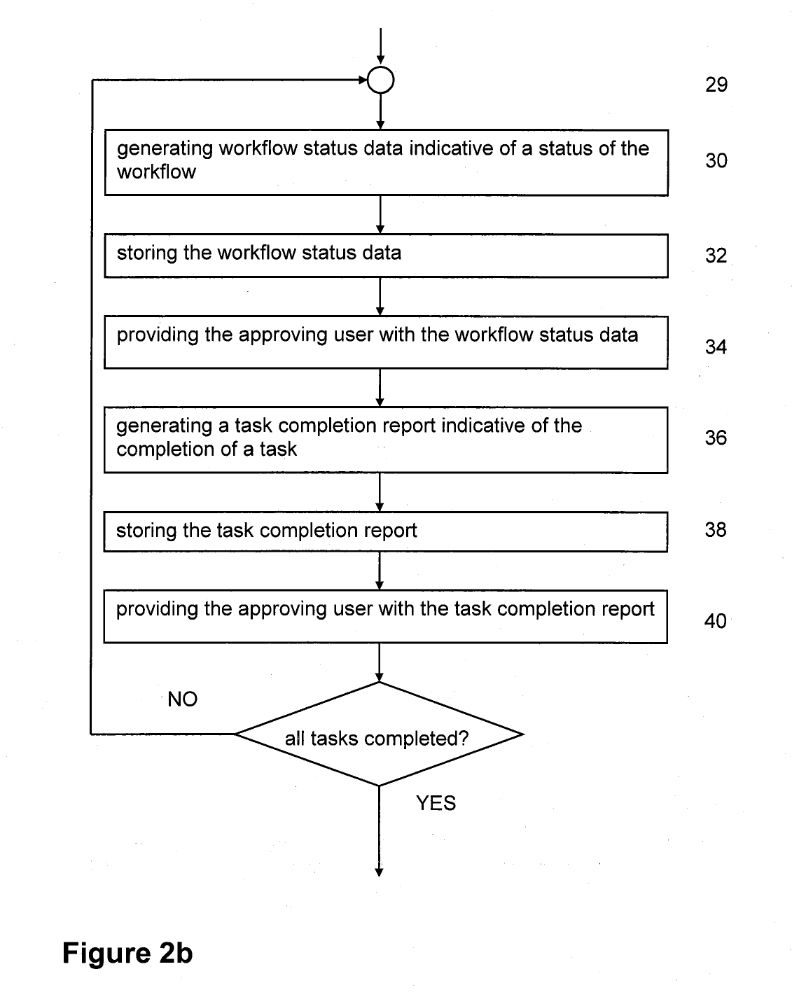

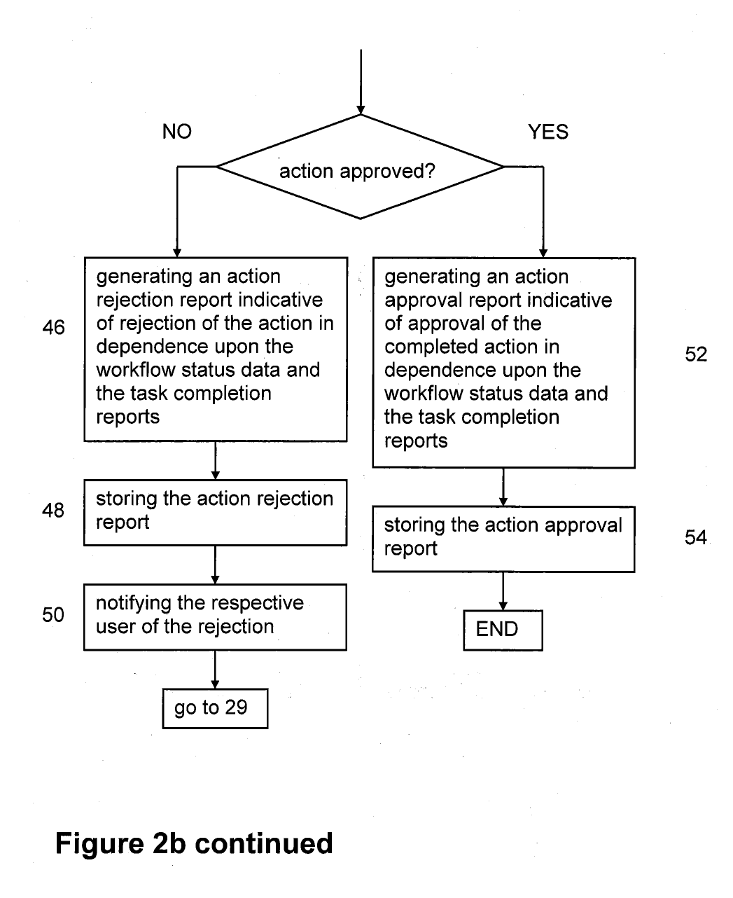

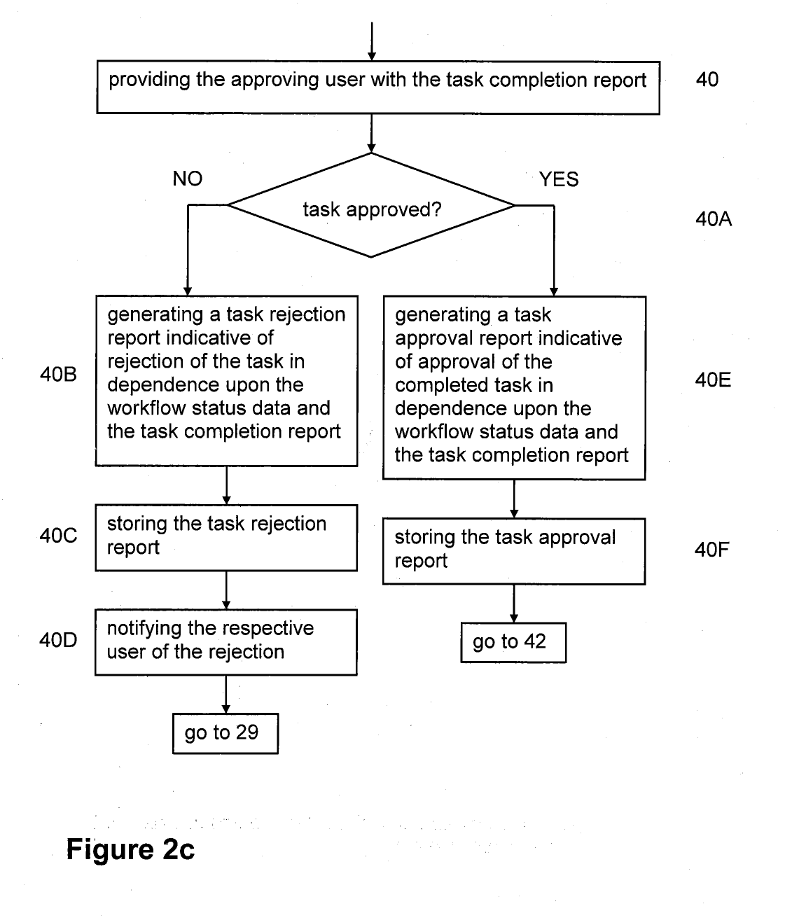

Referring to FIGS. 1 and 2a to 2c, a method for providing workflow control according to one embodiment of the invention is provided together with an embodiment of a system for its implementation. Execution of the workflow control is performed using processor 104 of server computer 102, for example, by executing executable commands stored in memory 106 of the server computer 102. Workflow templates, action workflows, reports, as well as other control data are stored in database 108 which is connected to the server computer 102 via a computer network 110 such as, for example, a Local Area Network (LAN) or a business or corporation. An administrator has privileged access to the server computer 102 and the workflow control via client computer 112—such as, for example, a workstation—connected to the server computer 102 via the computer network 110. The administrator is enabled to communicate with the workflow control executed on the processor 104 of the server computer 102 providing commands using, for example, keyboard 120 and receiving output data on graphical display 118 of the client computer 112. Communication between the client computer 112 and the processor 104 of the server computer 102 is provided by processor 114 of the client computer 112 executing, for example, executable commands stored in memory 116 of the client computer 112. For example, the administrator creates workflow templates, control process templates, report templates, and manages operation of the workflow control as well as the database.

Users performing tasks or uploading a request to perform an action access the server computer 102 using the client computer 112. For example, users working within a business or corporation use computers that are connected to the server computer 112 via the LAN 110. Alternatively, users access the server computer 102 using a client computer 132A, 132B which is connected to the LAN 110 via a computer network 130 such as the Internet. For example, contractors or vendors outside the business or corporation are included in the workflow control by enabling Internet access thereto.

A user is enabled to communicate with the server computer 102—for example, uploading a spreadsheet comprising a list of actions to be performed—using the user interaction devices 138A, 138B, 140A, and 140B for providing commands and displaying output data. Communication between the client computer 132A, 132B and the processor 104 of the server computer 102 is provided by processor 134A, 134B of the client computer 132A, 132B executing, for example, executable commands stored in memory 136A, 136B of the client computer 132A, 132B, respectively. Optionally, the client computer 132B is a mobile device connected via a wireless computer network, as indicated by the dashed line.

In one case, the method for providing workflow control is implemented using standard programming techniques and languages such as, for example, object oriented programming techniques and standard querying languages. In another case, output data such as report data are provided in formats that are compatible with standard business software applications to enable communication therewith. For example, relevant data of approval or rejection reports stored in the database 108 are accessible to business software applications for performing an audit at a later date.

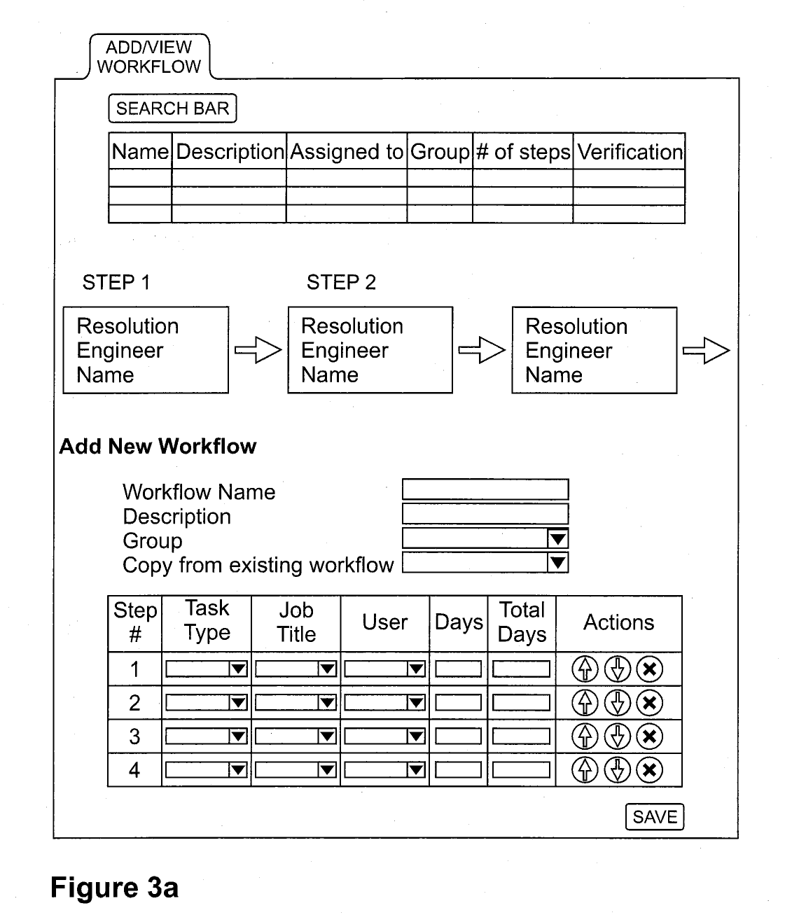

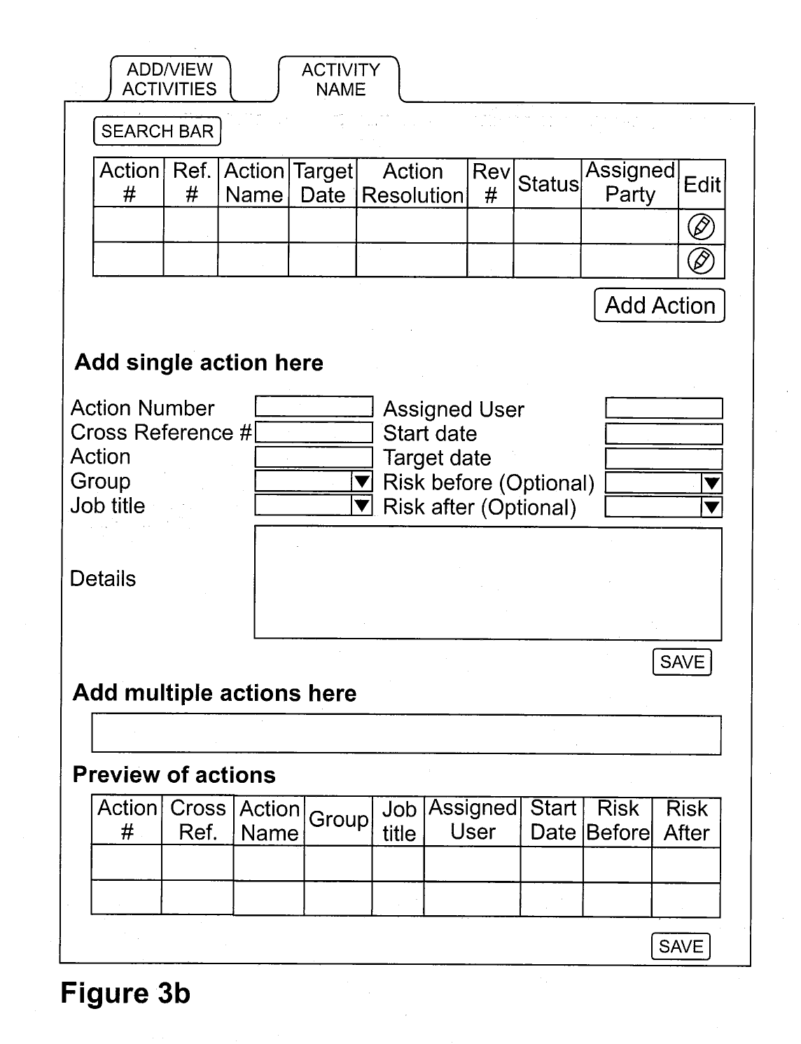

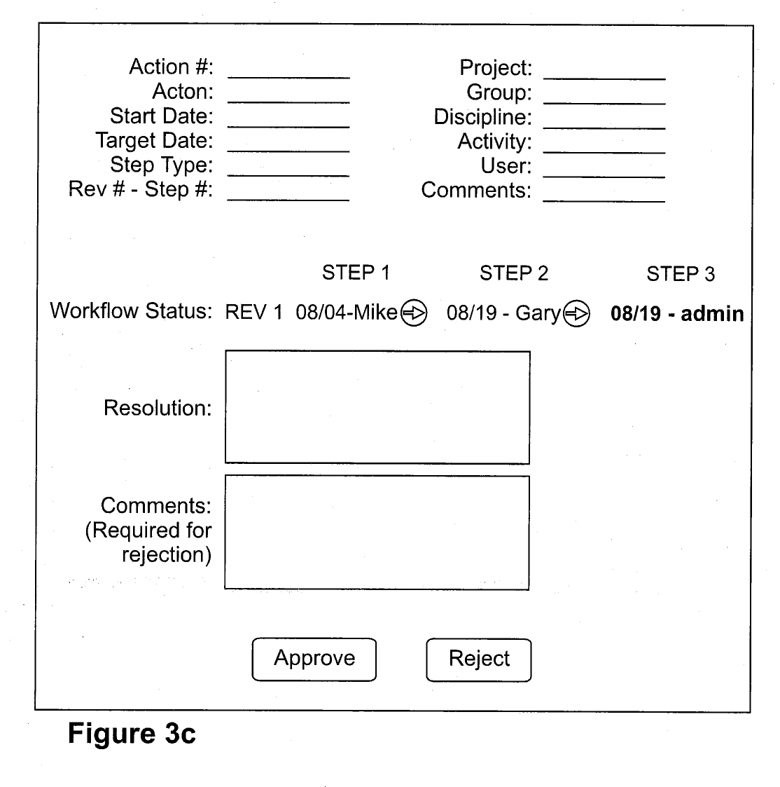

Referring to FIG. 2a, a first phase—generation of workflows and associated control processes—of the method for providing workflow control according to one embodiment of the invention is provided. At 12, a workflow template is provided for each action of a plurality of actions related to an activity. Each action comprises at least a task to be performed by at least a user. For example, the administrator creates the workflow templates using a wizard for facilitating creation of the same by, for example, graphically displaying components thereof—as illustrated in FIG. 3a—and enabling the administrator to select the appropriate components and to combine them to an appropriate workflow. The created workflow templates are then stored, for example, in the database 108. The workflow template for each action is then associated—14—with a respective predetermined control process template. For example, the administrator creates the control process templates using a wizard for facilitating creation of the same in similar fashion as described above with respect to the creation of the workflow templates. The control process templates comprise, for example, information such as: request of approval after completion of specific tasks; criterions of approval (for example, tolerances of a received product); and a time line for completing specific tasks. The created control process templates are then stored, for example, in the database 108. In one case, the administrator also creates various report templates for reports indicating completion of a task, approval/rejection of a task and approval/rejection of the completed action. As described above, creation of the report templates is facilitated by provision of a wizard.

At 16, a user is assigned to each of the tasks of the workflow templates. The assigned user is responsible for performing the task or for the completion of the task. An approving user is then assigned—18—to the action. The approving user is responsible for approving the completion of the action in dependence upon the corresponding control process template. Optionally, the approving user is also responsible for approving the completion of one or more specific tasks of the action. Alternatively, a different user is assigned for approving the specific task. The administrator assigning the users and approving user may be assisted by a wizard as illustrated in FIG. 3a. The assignments are then stored in association with the corresponding workflow templates and control process templates, for example, in the database 108.

At 20, a request indicative of an action to be performed is received. In one case, the request is uploaded in the form of a spreadsheet comprising a list of one or more actions to be performed. For example, each request comprises: data indicative of the activity the requested action is related to; data indicative of the user group associated with the action; and data indicative of a completion date. Optionally, a user is assisted in creating the spreadsheet by provision of a wizard displaying, for example, various user groups, jobs, titles, and actions associated with each user group for the requesting user to select therefrom, as illustrated in FIG. 3b. For example, the request is provided via the mobile device 132B connected to the server computer 102 via the Internet, as illustrated in FIG. 1.

Upon receipt of the request, a workflow and an associated control process is generated—22—for the action—for each action of the uploaded spreadsheet—in dependence upon the respective workflow template and the associated control process template. For example, upon receipt the spreadsheet document is parsed and each entry associated with an action is verified. The verification comprises, for example, a comparison of the data indicative of a user or user group and the data indicative of the action with respective data stored in the database. Upon positive verification of each entry the spreadsheet is accepted. Failure of the verification process results in the rejection of the spreadsheet document. Step 22 provides the generation of a workflow and an associated control process assigned to a corresponding action in an automated fashion based on the data indicative of a user or user group and the action.

At 24, data indicative of the workflow for the action, the associated control process, the users, and the approving user are stored, for example, in the database 108. Each user is then notified of the assigned task in dependence upon the workflow—26—and the approving user is notified of the assigned action—28. Each user may be provided with a due date for completing the task. Further, the approving user may be provided with the due dates for completing each of the tasks of the action together with the due date for completing the action. The notification is provided, for example, in the form of an email message. Optionally, the users are notified of the assigned task in dependence upon the status of the workflow. For example, in a situation where the performance of a task depends on the completion of one or more previous tasks a user is notified after completion of the previous tasks.

Referring to FIG. 2b, a second phase—execution of workflows and associated control processes—of the method for providing workflow control according to one embodiment of the invention is provided. During the execution of the workflow, workflow status data indicative of a status of the workflow are generated—30—and stored—32. In one case, the workflow status data are provided—34—to the approving user, for example, in the form of an email message. Upon completion of a task, the respective user generates—36—a task completion report which is stored —38—and, in one case, provided—40—to the approving user. For example, each user is provided with a task completion report template the user has to complete with data indicative of completion of the task and, optionally, enables the user to provide comments related to the task. The steps 30 to 40 are repeated until all tasks of the action are completed. When all tasks are completed the approving user may be notified and provided with the task completion reports for approving the action.

If the action is approved the approving user generates—52—an action approval report indicative of approval of the completed action in dependence upon the workflow status data and the task completion reports. For example, the approving user is provided with an action completion report template—an example of which is illustrated in FIG. 3c—the approving user has to complete with data indicative of approval of the action and, optionally, enables the approving user to provide comments related to the action. The action approval report is then stored—54.

If the action is rejected the approving user generates—46—an action rejection report indicative of rejection of the completed action in dependence upon the workflow status data and the task completion reports. For example, the approving user is provided with an action completion report template—an example of which is illustrated in FIG. 3c—the approving user has to complete with data indicative of rejecting of the action and, in one case, is required to provide comments related to rejection. The action rejection report is then stored—48—and the respective user or users are notified of the rejection—50. For example, the workflow—steps 30 to 40—is then repeated to overcome the rejection.

Optionally, when a task is completed the approving user is notified and provided with the task completion report for approving the task, as illustrated in FIG. 2c. For example, tasks deemed to be critical for the completion of the action are selected for approval prior continuation of the workflow. If the task is approved—40A—the approving user generates—40E—a task approval report indicative of approval of the completed task in dependence upon the workflow status data and the task completion report. For example, the approving user is provided with a task completion report template the approving user has to complete with data indicative of approval of the task and, optionally, enables the approving user to provide comments related to the task. The task approval report is then stored—40F.

If the task is rejected—40A—the approving user generates—40B—a task rejection report indicative of rejection of the completed task in dependence upon the workflow status data and the task completion report. For example, the approving user is provided with a task completion report template the approving user has to complete with data indicative of rejecting of the task and, in one case, is required to provide comments related to rejection. The task rejection report is then stored—40C—and the respective user is notified of the rejection—40D. For example, the workflow—steps 30 to 40—is then repeated to overcome the rejection.

The present invention has been described herein with regard to certain embodiments. However, it will be obvious to persons skilled in the art that a number of variations and modifications can be made without departing from the scope of the invention as described herein.

What is claimed is:

1. A method for generating a workflow control process comprising:
providing a workflow template for each action of a plurality of actions, each action comprising at least a task to be performed by at least a user;
associating the workflow template for each action with a respective predetermined control process template;
assigning a user to each of the tasks of the workflow templates;
assigning an approving user responsible for approving completion of the action in dependence upon the control process template;
receiving a request indicative of an action to be performed;
generating a workflow for the action and an associated control process in dependence upon the respective workflow template and the associated control process template;
storing data indicative of the workflow for the action, the associated control process, the users, and the approving user;
notifying each user of the assigned task in dependence upon the workflow; and,
notifying the approving user of the assigned action.

2. A method for generating a workflow control process as defined in claim 1 comprising:
generating workflow status data indicative of a status of the workflow; and,
storing the workflow status data.

3. A method for generating a workflow control process as defined in claim 2 wherein the users are notified of the assigned task in dependence upon the status of the workflow.

4. A method for generating a workflow control process as defined in claim 3 comprising:
generating a task completion report indicative of the completion of a task; and,
storing the task completion report.

5. A method for generating a workflow control process as defined in claim 4 comprising providing the approving user with the workflow status data.

6. A method for generating a workflow control process as defined in claim 5 comprising providing the approving user with the task completion report.

7. A method for generating a workflow control process as defined in claim 6 comprising:
generating an action approval report indicative of approval of the completed action in dependence upon the workflow status data and the task completion report; and,
storing the action approval report.

8. A method for generating a workflow control process as defined in claim 7 wherein the control process comprises at least a decision criterion and wherein the action approval report is generated in dependence upon the at least a decision criterion.

9. A method for generating a workflow control process as defined in claim 6 comprising:
generating an action rejection report indicative of rejection of the action in dependence upon the workflow status data and the task completion report;
storing the action rejection report; and,
notifying the respective user of the rejection.

10. A method for generating a workflow control process as defined in claim 1 comprising receiving a plurality of requests in the form of a spreadsheet document, each request being indicative of an action to be performed.

11. A method for generating a workflow control process as defined in claim 10 comprising parsing the spreadsheet document and verifying each entry associated with an action.

12. A method for generating a workflow control process as defined in claim 11 comprising retrieving the respective workflow template and the associated control process template for each action.

13. A storage medium having stored therein executable commands for execution on a processor, the processor when executing the commands performing:
providing a workflow template for each action of a plurality of actions, each action comprising at least a task to be performed by at least a user;
associating the workflow template for each action with a respective predetermined control process template;
assigning a user to each of the tasks of the workflow templates;
assigning an approving user responsible for approving completion of the action in dependence upon the control process template;
receiving a request indicative of an action to be performed;
generating a workflow for the action and an associated control process in dependence upon the respective workflow template and the associated control process template;
storing data indicative of the workflow for the action, the associated control process, the users, and the approving user;
notifying each user of the assigned task in dependence upon the workflow; and, notifying the approving user of the assigned action.

14. A storage medium as defined in claim 13 wherein the processor when executing the commands performs:
generating workflow status data indicative of a status of the workflow; and,
storing the workflow status data.

15. A storage medium as defined in claim 13 wherein the processor when executing the commands performs:
generating a task completion report indicative of the completion of a task;
storing the task completion report; and,
providing the approving user with the task completion report.

16. A storage medium as defined in claim 15 wherein the processor when executing the commands performs:
generating an action approval report indicative of approval of the completed action in dependence upon the workflow status data and the task completion report; and,
storing the action approval report.

17. A storage medium as defined in claim 15 wherein the processor when executing the commands performs:
generating an action rejection report indicative of rejection of the action in dependence upon the workflow status data and the task completion report;
storing the action rejection report; and,
notifying the respective user of the rejection.
